(19) United States
(12) Patent Application Publication
(10) Pub. No.: US 2003/0027325 A1
(43) Pub. Date: Feb. 6, 2003

(54) Method for processing alkene-containing exhaust gas

(75) Inventors: Keh-Perng Shen, Hsinchu Hsien (TW); Shu-Kang Hsu, Kaohsiung Hsien (TW); Ching-Chih Lai, Hsinchu (TW)

Correspondence Address: DARBY & DARBY P.C., 805 Third Avenue, New York, NY, 10022, US

(73) Assignee: Industrial Technology Research Institute, Hsinchu (TW)

(21) Appl. No.: 10/085,461

(22) Filed: Feb. 27, 2002

(30) Foreign Application Priority Data
Jul. 2, 2001 (TW) 90116092

(51) Int. Cl. C12S 5/00

(52) U.S. Cl. 435/266; 423/230; 423/245.1

(57) ABSTRACT

The invention discloses a method for processing alkene-containing exhaust gas. It is a combination of ozonic and biological processes which mainly deal with exhaust gas mixtures having alkene-containing (C—C double bond) organic exhaust gas (such as alkene, acrylic acid) and other volatile organic compounds (such as ketone, alcohol, BTEX, and others). Since exhaust gas containing C—C double bond is difficult to dispose of, the method for processing exhaust gas presented in the invention utilizes ozone to completely decompose or transform the organic contaminants with C—C double bonds into intermediate products. The organic contaminant can then be treated in the biological process and converted into non-toxic substances. This method does not require large-sized biological process equipment, and the residual ozone is oxidized and degraded in the bio-filter.

### BACKGROUND OF THE INVENTION

1. Field of the Invention

The present invention relates to a method for processing alkene-containing exhaust gas, in particular, a combined ozone and biological technology to decompose alkene-containing exhaust gas to non-toxic substances.

2. Description of the Prior Art

Exhaust gas containing volatile organic compounds (VOCs) or noxious components are generally processed by incineration (thermal incineration, catalytic incineration, boiler, flare), adsorption with activated carbon, concentration followed by incineration, or condensation, biological process (bio-filter, bio-trickling filter, bio-scrubber) or wet scrubber. If the concentration of the pollutants in exhaust gas is less than 1000 ppmv, with lower flowrate (<200 CMM), and the pollutant is bio-degradable, the biological process is the best choice, considering the operating costs and capital costs.

In a biological process, pollutants in the exhaust gas are degraded by microorganisms to produce non-toxic water, CO₂ and other inorganic salts. It is an economical process that reduces secondary pollution and consumes lower energy. It is widely known as a “clean” process. The advantage of a biological process is lower operation cost, but longer retention time and larger equipment size have hindered applicability, in particular, with relatively hard to bio-degradable (such as phenol and butadiene, whose process time must be at least 1 minute to achieve a removal rate of 90%). In order to meet the requirements of related regulations, longer retention time is often required, which substantially increases the size of the equipment. As a result, if the issue regarding longer retention time is resolved, biological process would be more widely applied to deal with VOCs or noxious compounds in exhaust gas.

Exhaust gas can also be processed by other methods, but if chemical scrubbing or advanced oxidization technology (such as UV, UV/ozone, ozone, H₂O₂/ozone, H₂O₂/Fe²⁺) is applied, operation costs are considerably high. Incineration is also an option, however, the processing temperature must be raised to hundreds of degrees, and, with the insufficient heat value of exhaust gas, large amounts of fuel are needed to preheat the exhaust gas. Consequently, costs go up and the extra carbon dioxide produced causes pollution. These disadvantages have made this method a poor choice.

At the moment, in a biological process, pollutants such as hardly biodegradable alkenes are usually dealt with by increasing the retention time of the exhaust gas. To incorporate this increased reaction time, the process equipment must be prohibitively large, in which case the method is infeasible. U.S. Pat. No. 5,861,303 discloses a chemical pretreatment to remove acid/base substances or to reduce pollutant concentration in exhaust gas so that harmful substance to microorganisms is avoided. However, the oxidation ability of the oxidizing agent (such as hypochloride sodium) to the VOCs (particularly compounds with double bond, such as alkenes) is limited, and cannot effectively reduce the concentration of VOCs. Moreover, resistance for the mass transfer between gas and liquid is increased in wet scrubbing. In the '303 patent, upflow mode is adopted to avoid introducing excess amounts of oxidizing agent and causes the reduction of microorganisms in the bio-filter. However, this method is not advantageous with respect to the water content of the filter material, consequently the bottom part of the bio-filter, near the gas inlet, is not humidified due to the counter current flow of the gas (exhaust gas) and liquid (water sprinkled on top part of the filter bed). Moreover, the temperature is increased and the surrounding is dried due to the decomposition heat released by the biodegradation at the initial contact when the pollutant's concentration of exhaust gas is high, which lowers the processing efficiency of the bio-filter.

### SUMMARY OF THE INVENTION

In order to overcome the above problems, the invention uses ozone as its oxidizing agent, due to its ability to oxidize VOCs. Particularly, it effectively lowers the loadings of a bio-filter when dealing with compounds containing double bonds. Meanwhile, ozone is mixed with exhaust gas in a gas state, in which the effect of contact is better than gas-liquid contact (wet scrubbing). In order to avoid using upflow, as adopted in the '303 patent, using ozone as the oxidizing agent, whether upflow or downflow is adopted for the exhaust gas after chemical pretreatment to enter the biological process equipment, excess oxidizing agent will not be introduced into the bio-filter bed to adversely affect the microorganisms found there.

The oxidizing ability of ozone is not particularly strong to VOCs, however, it attacks double bonds contained in a compound fairly easily. Thus, substances having carbon double bonds (such as pollutants containing alkenes) are easily broken down into small pieces that are easily bio-degradable. This will resolve the problem of the increased size required when adopting biological process to deal with hardly bio-degradable compounds. Application of the method of the invention covers exhaust gas treatment for petrochemical and plastics industries, such as exhaust gas containing butadiene and styrene from ABS process, or exhaust gas containing norbornene from m-COC process.

Hence, the present invention discloses a method for processing alkene-containing compounds and widely known noxious components, such as hydrogen sulfide, methanethiol, ethanethiol or dimethyl sulfide. The method makes use of the strong reactivity of ozone and carbon double bonds to decompose carbon double bonds at room temperature, decompose the alkene-containing compounds to CO₂ and H₂O completely, or partially decompose the alkene-containing compounds to other intermediates that are easily bio-degradable to be further processed in the subsequent biological process equipment (such as bio-filter). As well, additional equipment and costs associated with the breakdown of the remaining ozone are not required in this method, thanks to the substances that are able to oxidize and break down the unreacted ozone existing in the large amount of animal compost (being reductive in nature) in the biological filter material. As a result, the present invention employs a combined ozone and biological process, primarily using ozone to decompose compounds (alkenes, such as butadiene) that are not easily bio-degraded into smaller, bio-degradable molecules, followed by biological process (carried out in apparatus such as bio-filter, bio-trickling filter, bio-scrubber). Consequently, large biological process equipment is not necessary, and costs are reduced. Additionally, ozone process equipment and biological process equipment are not required to be contained within a single apparatus, they can be two individual apparatus.

The advantages of the present invention are: the processing efficiency for exhaust gas containing compounds that are difficult to bio-degrade (particularly alkene-containing compounds) is increased, and the size of biological process equipment is effectively reduced. In addition, downflow can be adopted as the mode for gas inlet to the bio-filter, is not restricted, and is able to treat the exhaust gas. Furthermore, pollutants that are easily degradable are processed in a biological pretreatment, followed by ozone process to handle the pollutants containing alkenes. The total elimination efficiency of hydrocarbons removed is high and the size of the biological process equipment is also decreased.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a flowchart of the method for processing alkene-containing exhaust gas according to the embodiment of the present invention.

FIG. 2 illustrates the concentration of Norbornene before the process.

FIG. 3 illustrates the concentration of Norbornene after the process.

FIG. 4 illustrates the concentration of mCOC exhaust gas before the process.

FIG. 5 illustrates the concentration of mCOC exhaust gas after the process.

FIG. 6 illustrates the concentration of styrene before the process.

FIG. 7 illustrates the concentration of styrene after the process.

### DETAILED DESCRIPTION OF THE INVENTION

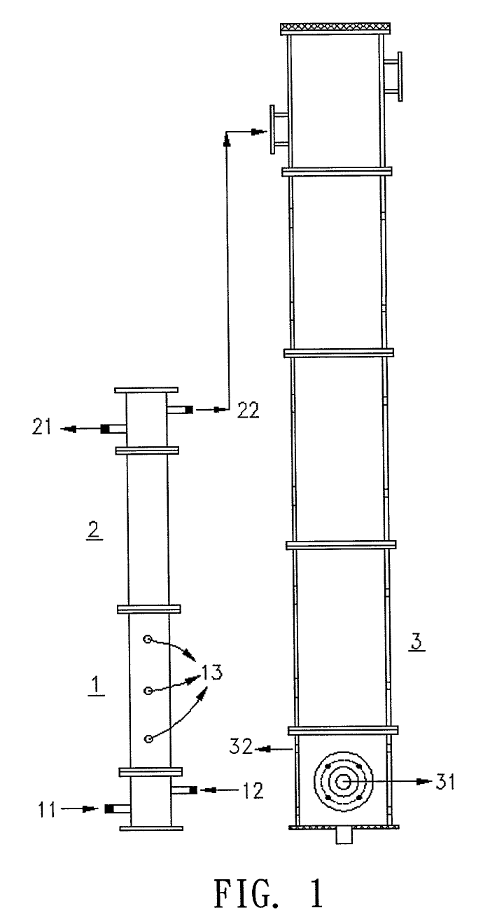

In FIG. 1, before exhaust gas 11, which contains VOCs having alkenes (carbon double bonds) enters the bio-filter bed 3 (or other biological process equipment), the exhaust gas 11 passes an ozone reactor 1, in which ozone 12 is used to attack carbon-carbon double bonds and completely oxidize or breakdown VOCs with double bonds into smaller molecular fragments. At this time, samples can be taken at sampling window 13 to test the components of gas reacted with ozone. Next, tail gas 22, is introduced after the ozone process into the bio-filter bed 3 (or other biological process equipment) to be decomposed by microorganisms. The obtained tail gas 31 after biological process can be sampled at sampling window 32 by gas chromatography. The preferred additive amount of ozone is 0.1˜10 times of the concentration of the pollutants, more preferably 0.5˜5.

In addition, the exhaust gas is directed into a filter material compost compartment 2 before entering bio-filter bed 3 to destroy the residual ozone. Samples can also be taken at sampling window 21 to test the components of gas at this stage.

With the method of the present invention, it is not necessary to increase the size of the biological process equipment to allow longer retention time for the decomposition of alkene-containing compounds in the exhaust gas, or to adopt other costly processes with high operating costs. Furthermore, other compounds in the exhaust gas that are not alkene-containing cannot be processed by ozone, and are treated biologically. This method has advantages of both ozone and biological process, but none of the shortcomings

The mode for the ozone to enter the exhaust gas can be porous aeration stones, aeration plate or other suitable means. The contact of the exhaust gas and ozone is either executed by the design of piping (such as venturi throat or static mixer) to result in a countercurrent, or by packed bed. The filler for the packed bed is either structural or random. The material is stainless steel, iron, metal or plastic. The packed bed is either packed column or sieve plate column. The packing for the packed column, and the sieve plates for the sieve plate column are stainless steel or other material that is ozone-resistant. In addition, the filler, the sieve plates, venturi, and static mixer, further comprise a catalytic substance that promotes the decomposition of ozone.

The mode for the exhaust gas processed by ozone to enter the biological process equipment is upflow, downflow or crossflow. It is not restricted by the effect of ozone on the microorganisms in the biological process equipment. The material stacked in the filter material compost compartment 2 is organic substance or other material that is able to decompose ozone, such as activated carbon, MnO₂, FeO(OH), or Ag.

The method of the present invention further comprises a monitoring step for exhaust gas, in which the pollutant concentrations before and after the process are observed to adjust the ozone supply accordingly. The inspection item in the monitoring step is the total concentration of hydrocarbons in the exhaust gas or the concentration of the compound reactive with ozone. The regulation of ozone supply is adjusted according to the ozone concentration or the flowrate of the ozone supply.

### PREFERRED EMBODIMENTS

1^{ST} Embodiment

Exhaust gas containing styrene, norbornene and butyl acrylate was used in this embodiment. The inlet concentration of ozone was 110 ppmv. The ozone in the tail gas has been decomposed by flow through a compost compartment that was 20 cm height in 3 sec of contact time, before entering the bio-filter. The concentration of ozone was reduced to below 1 ppmv. The concentration of above-described compounds before and after the process is listed in Table 1.

TABLE 1

| | Ozone process | | | Biological process | | |
|---|---|---|---|---|---|---|
| | Concentr | | | Concentr | | |
| | ation | Reaction | | ation | Reaction | |
| Pollutant | (ppmv) | time (s) | Efficiency | (ppmv) | time (s) | Efficiency |
| styrene | 150 | 1 | 99+% | | | |
| Norbornene | 40 | 1 | 99+% | | | |
| Toluene | 40 | 1 | ˜0% | 40 | 60 | 99+% |
| Acetone | 100 | 1 | ˜0% | 100 | 60 | 99+% |
| Ethyl | 16 | 3 | 10% | | | |
| Acrylate | | | | | | |
| Butyl | 13 | 3 | 64% | | | |
| Acrylate | | | | | | |

2^{nd} Embodiment

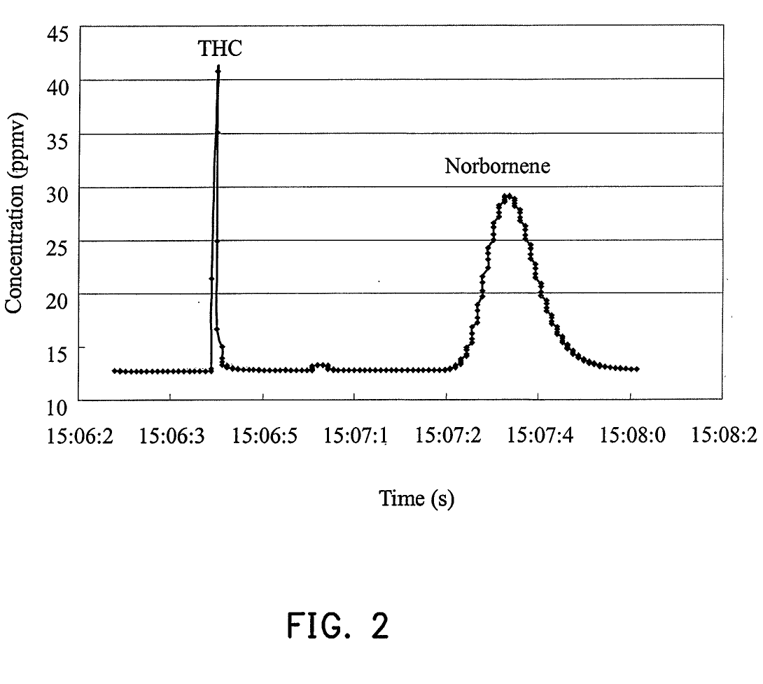

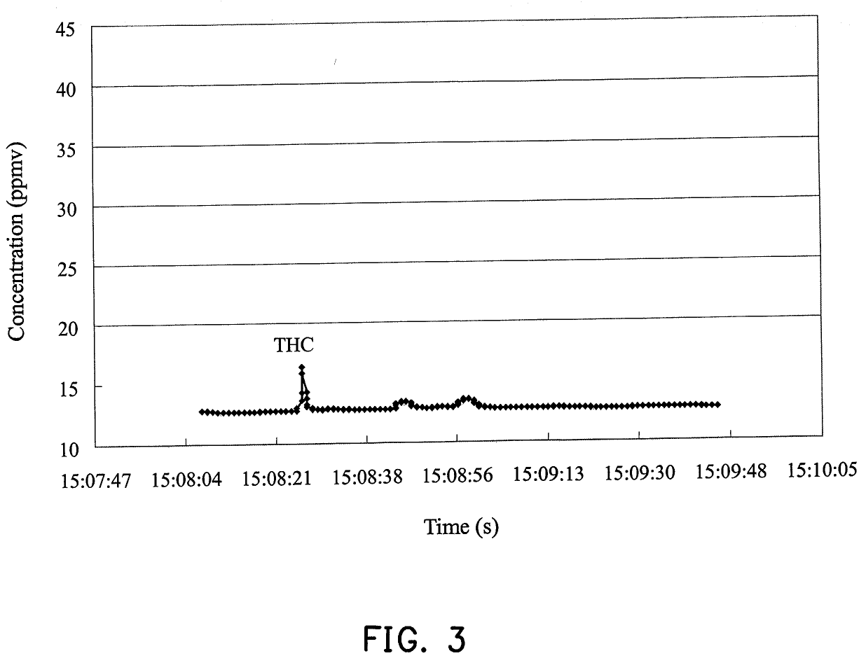

Apart from processing a single pollutant (Norbornene), the operating condition is the same as that in the 1^{st} Embodiment. The concentration before the process is shown in FIG. 2. FIG. 3 illustrates the concentration after the process.

3^{rd} Embodiment

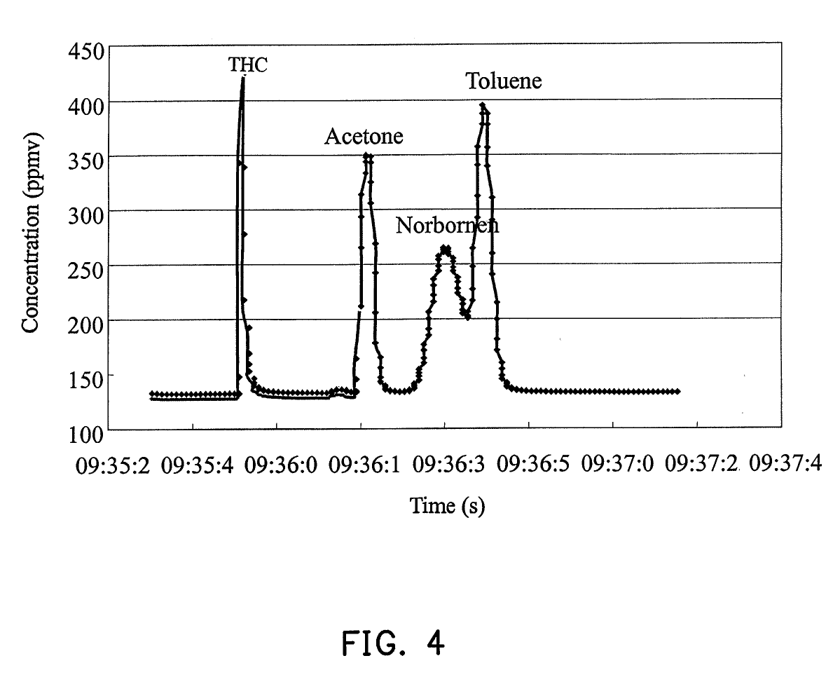

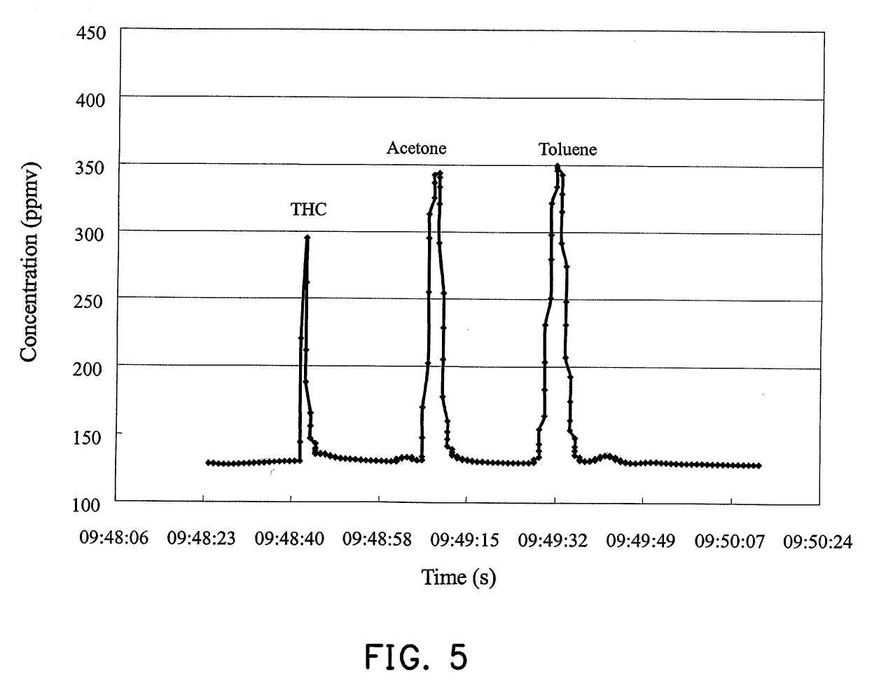

Apart from processing an exhaust gas from mCOC process, the operating condition is the same as that in the 1^{st} Embodiment. The concentration before the process is shown in FIG. 4, while FIG. 5 illustrates the concentration after the process. The inlet concentration of ozone was 50 ppmv, and the reaction time was 1 sec.

4^{th} Embodiment

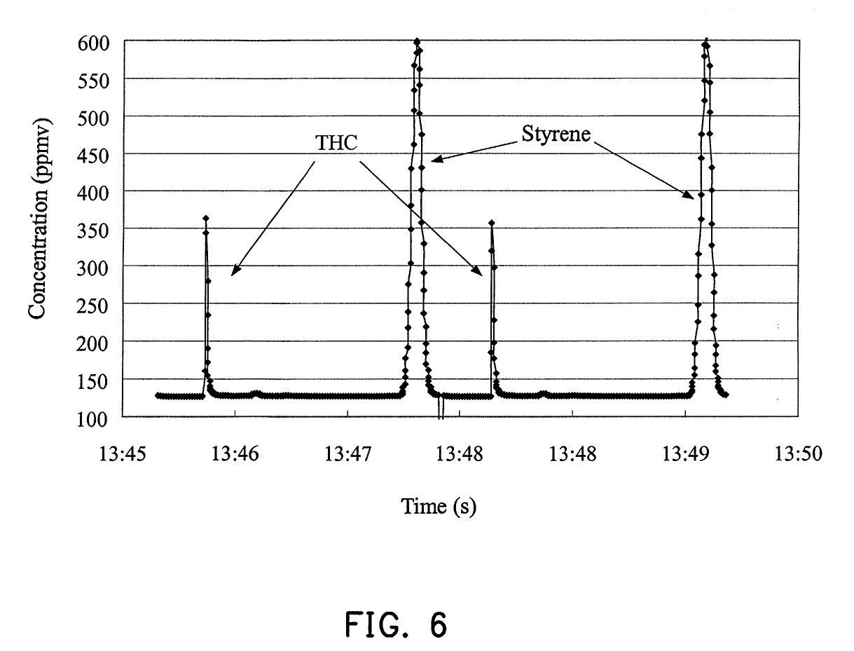

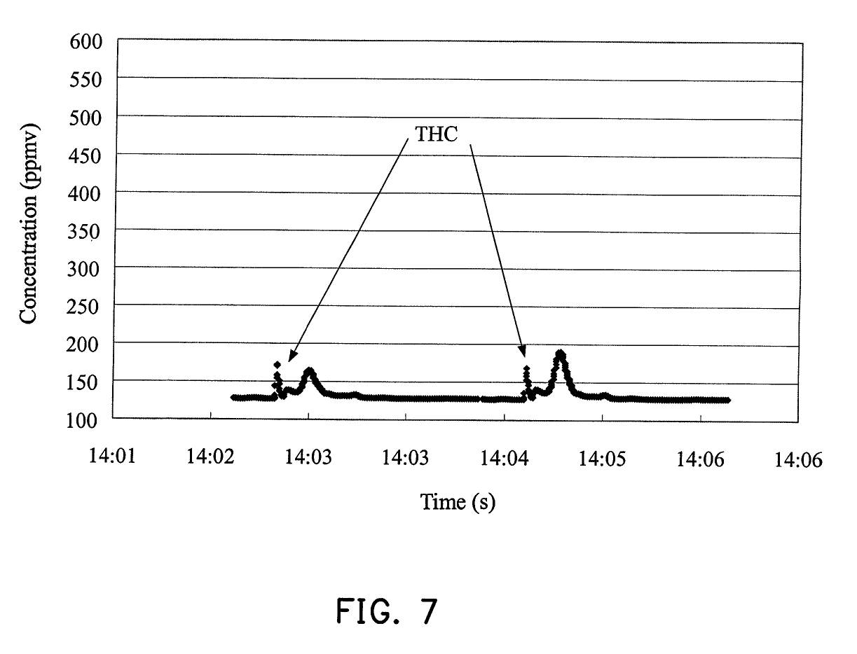

Apart from processing styrene, the operating condition is the same as that in the 1^{st} Embodiment. The concentration before the process is shown in FIG. 6, while FIG. 7 illustrates the concentration after the process. The inlet concentration of ozone was 106 ppmv, and the reaction time was 1 sec.

From the above graphs, it can be seen that the invention's method for processing alkene-containing exhaust gas greatly improves the processing efficiency, to 99%. Moreover, the retention time for biological process is controlled to about 60 seconds, and equipment size requirements are effectively reduced.

What is claimed is:

1. A method for processing alkene-containing exhaust gas, comprising:
ozonation process, wherein the alkene-containing exhaust gas reacts with ozone and the double bond is completely oxidized and broken down into small molecules; and
biological process, wherein the small molecules are further reacted and decomposed.

2. The method as claimed in claim 1, wherein the ozone process is carried out in an apparatus selected from the group consisting of a gas pipe, a packed column and any device that promotes the blending of gases and the contact among gases.

3. The method as claimed in claim 2, wherein the equipment that promotes the contact among gases is selected from the group consisting of venturi pipes and static blender.

4. The method as claimed in claim 3, the material of the venturi pipes and static blender is selected from the group consisting of stainless steel and other material that is resistant to ozone.

5. The method as claimed in claim 2, the processing equipment filled with a filler is selected form the group consisting of packed columns and sieve plate columns.

6. The method as claimed in claim 5, wherein the material of the filler or the sieve plate of the sieve plate column is selected from the group consisting of stainless steel and other material that is resistant to ozone.

7. The method as claimed in claim 4 or 6, wherein the filler, sieve plate, venturi pipe and the static mixer further comprise a catalytic substance that accelerates the decomposition of ozone.

8. The method as claimed in claim 1, further comprising a step of decomposing residual ozone before the exhaust gas entering the biological process.

9. The method as claimed in claim 8, wherein the decomposition of the residual ozone is carried out in a filter material compost compartment.

10. The method as claimed in claim 9, wherein the material filling the filter material compost compartment is selected from the group consisting of organic substances and other substances that decompose ozone.

11. The method as claimed in claim 10, wherein the substance that decomposes ozone is activated carbon, MnO₂, FeO(OH), or Ag.

12. The method as claimed in claim 1, wherein the biological process is carried out in a device selected form the group consisting of bio-filter, a bio-trickling filter and a bio-scrubber.

13. The method as claimed in claim 12, wherein the means by which the exhaust is introduced into the bio-filter bed is selected form the group consisting of upflow and downflow.

14. The method as claimed in claim 12, wherein the means by which the exhaust gas is introduced into the bio-trickling filter or the bio-scrubber is selected from the group consisting of upflow, downflow and crossflow.

15. The method as claimed in claim 1, wherein the ozonic process equipment and the biological process equipment are combined as a single apparatus.

16. The method as claimed in claim 1, wherein the ozonic process equipment and the biological process equipment are two individual apparatus.

17. The method as claimed in claim 1, wherein the alkene-containing exhaust gas comprises styrene, butadiene, norbornene, and acrylates.

18. The method as claimed in claim 17, wherein the acrylates are acrylic acetate and butyl acrylate.

19. The method as claimed in claim 1, wherein the noxious component of the alkene-containing exhaust gas is hydrogen sulfide, methanethiol, ethanethiol and dimethyl sulfide.

20. The method as claimed in claim 1, wherein the amount of ozone added is 0.1˜10 times that of the pollutant.

21. The method as claimed in claim 1, wherein the amount of ozone added is 0.5˜5 times that of the pollutant.

22. The method as claimed in claim 1, further comprising a monitoring step for exhaust gas, in which the pollutant concentrations before and after the process are observed to adjust the ozone supply accordingly.

23. The method as claimed in claim 22, wherein the inspection item in the monitoring step is selected from the group consisting of the total concentration of hydrocarbons in the exhaust gas and the concentration of the compound reactive with ozone.

24. The method as claimed in claim 22, wherein the regulation of ozone supply is adjusted according to a factor selected form the group consisting of the ozone concentration and the flowrate of the ozone supply.
